(19) United States
(12) Patent Application Publication
(10) Pub. No.: US 2007/0169851 A1
(43) Pub. Date: Jul. 26, 2007

(54) Soft magnetic material and dust core

(76) Inventors: Hirokazu Kugai, Hyogo (JP); Naoto Igarashi, Hyogo (JP); Toru Maeda, Hyogo (JP); Kazuhiro Hirose, Hyogo (JP); Haruhisa Toyoda, Hyogo (JP); Koji Mimura, Hyogo (JP); Takao Nishioka, Hyogo (JP)

Correspondence Address: MCDERMOTT WILL & EMERY LLP, 600 13TH STREET, N.W., WASHINGTON, DC, 20005-3096, US

(21) Appl. No.: 10/587,893

(22) PCT Filed: Jan. 26, 2005
(86) PCT No.: PCT/JP05/01433

§ 371 Date: Jul. 28, 2006

(30) Foreign Application Priority Data
Jan. 30, 2004 (JP) 2004-024257

(51) Int. Cl. H01F 1/24

(52) U.S. Cl. 148/306; 252/62.56

(57) ABSTRACT

An object of the present invention is to provide a soft magnetic material exhibiting excellent magnetic characteristics regardless of the frequency to be applied and a dust core produced from the soft magnetic material.

The means for solving the invention is a soft magnetic material that comprises metal magnetic particles 10 containing iron and oxygen. The ratio of oxygen contained in metal magnetic particles 10 is more than 0 and less than 0.05% by mass. A dust core produced using such a soft magnetic material has a coercive force of 2.0×10² A/m or less.

### TECHNICAL FIELD

The present invention relates to a soft magnetic material and a dust core. More specifically, it relates to a soft magnetic material for use in choke coils, motor cores, electromagnetic solenoids, and the like, and a dust core produced from the soft magnetic material.

### BACKGROUND ART

Hitherto, an increase in density and a decrease in size have been attempted in electrical and electronic components, such as motor cores and transformer cores. Further, accurate control and low power performance have been required. For this reason, soft magnetic materials that have excellent magnetic characteristics have been developed for use in the production of these electrical and electronic components.

With regard to dust cores produced using such soft magnetic materials, for example, JP-A-8-269501 discloses a high-frequency dust core, an iron powder for the high-frequency dust core, and processes for producing the same for the purpose of realizing a high AC initial magnetic permeability at a frequency of 100 kHz or lower. In the publication, a flat-processed iron powder containing 0.05% oxygen by mass is disclosed. In addition, JP-2001-196217 discloses a process for producing a dust core excellent in strength characteristics for the purpose of reducing iron loss and copper loss.

The dust cores produced using these soft magnetic materials have a large coercive force compared with that of cores produced using magnetic steel sheets, and hence hysteresis loss increases. Since the ratio of the hysteresis loss in the iron loss is particularly noticeable in a low-frequency region, magnetic steel sheets are frequently still utilized in a low-frequency region of 100 kHz or lower, although soft magnetic materials are sometimes utilized in a high-frequency region of more than 100 kHz.

Thus, an object of the invention is to solve the above problems and to provide a soft magnetic material exhibiting excellent magnetic characteristics regardless of a frequency to be applied and a dust core produced from the soft magnetic material.

### DISCLOSURE OF THE INVENTION

In the case that strains such as defect or dislocation or impurity phases are present in the inside of crystals of metal magnetic particles to be used in the production of dust cores, the strains inhibit magnetic domain wall transfer (flux change) and hence may cause a reduction in the magnetic characteristics of the dust cores. Among them, strains such as defects or dislocation can be reduced by carrying out thermal treatment, but the impurity phases are generally difficult to remove by thermal diffusion. Therefore, with regard to the magnetic characteristics of a dust core, the upper limit thereof is determined by the concentration of the impurities in the metal magnetic particles to be used.

In the case that the metal magnetic particles are composed of an iron-based metal containing iron (Fe), impurities particularly influencing magnetic characteristics to a large extent are substances that do not dissolve easily in iron, such as carbon (C), nitrogen (N), oxygen (O), sulfur (S), and phosphorus (P), which form nonmagnetic compounds with iron. In order to enhance the magnetic characteristics of the dust core, it is necessary to reduce the concentration of these substances.

Thus, as a result of extensive studies the present inventors have obtained findings that, of these substances, oxygen particularly strongly combines with iron, and hence it is necessary to set the ratio of oxygen contained in the metal magnetic particles to an appropriate range in order to enhance the magnetic characteristics of the dust core dramatically. Thus, based on such findings, the inventors have accomplished the invention.

The soft magnetic material according to the invention comprises metal magnetic particles containing iron and oxygen. The ratio of the above oxygen contained in the metal magnetic particles is more than 0 and less than 0.05% by mass.

In the thus constituted soft magnetic material, iron oxides such as FeO, Fe₂O₃, or Fe₃O₄, which are formed by the reaction between iron and oxygen, in the metal magnetic particles are contained. FeO and Fe₂O₃ are nonmagnetic compounds, and Fe₃O₄ is a magnetic compound but is low in magnetic flux density compared with that of Fe, so that these iron oxides decrease the magnetic flux density of the soft magnetic material.

However, in the invention, since the ratio of oxygen contained in the metal magnetic particles is suppressed to less than 0.05% by mass, the ratio of these iron oxides is reduced. Therefore, saturated magnetic flux density increases, and the transfer of the magnetic domain wall is facilitated, so that the coercive force of the soft magnetic material can be reduced. In addition, since the ratio of oxygen contained in the metal magnetic particles can be reduced by carrying out reductive annealing, the soft magnetic material in the invention can be easily obtained.

More preferably, the coercive force of the metal magnetic particles is 2.4×10² A/m or less. According to the thus constituted soft magnetic material, the hysteresis loss of the soft magnetic material can be sufficiently reduced. Thereby, increase in iron loss can be effectively prevented even when the soft magnetic material according to the invention is used in a low-frequency region.

Further preferably, the average particle size of the metal magnetic particles is from 100 μm and to 300 μm. According to the thus constituted soft magnetic material, by controlling the average particle size of the metal magnetic particles to 100 μm or more, the ratio of stress-strain induced by surface energy relative to the whole metal magnetic particles can be lowered. Thereby, the hysteresis loss of the soft magnetic material can be reduced. Moreover, by controlling the average particle size of the metal magnetic particles to 300 μm or less, eddy current loss in the particles of the metal magnetic particles can be reduced. Thereby, the iron loss of the soft magnetic material can be reduced. In addition, it is possible to prevent difficult meshing of the metal magnetic particles with one another at the time when a pressure-molding step is carried out using the soft magnetic material of the invention.

Still more preferably, the particle size distribution of the metal magnetic particles is substantially present only in the range of more than 38 μm. In the thus constituted soft magnetic material, particles having a large ratio of stress-strain induced by surface energy relative to the whole metal magnetic particles are excluded completely. Thereby, the hysteresis loss of the soft magnetic material can be sufficiently reduced.

Still further preferably, the soft magnetic material comprises a plurality of composite magnetic particles comprising the metal magnetic particles and insulating coated films surrounding the surface of the metal magnetic particles. According to the thus constituted soft magnetic material, by providing the insulating coated films, it is possible to suppress the flow of the eddy current among the metal magnetic particles. Thereby, the iron loss of the soft magnetic material caused by the eddy current among particles can be sufficiently reduced.

The dust core according to the invention is a dust core produced using the soft magnetic material described in any one of the above. According to the thus constituted dust core, since the core is produced using a soft magnetic material having a reduced coercive force, the iron loss of the dust core can be reduced particularly in a low-frequency region.

More preferably, the coercive force of the dust core is 2.0×10² A/m or less. According to the thus constituted dust core, the iron loss of the dust core can be sufficiently reduced even in a low-frequency region and the dust core produced using the soft magnetic material can be utilized regardless of the frequency to be applied.

### BRIEF DESCRIPTION OF THE DRAWINGS

FIG. 1 is a pattern diagram showing a dust core produced using a soft magnetic material in an embodiment of the invention.

FIG. 2 is a graph showing the relationship between a ratio of oxygen contained in atomized iron powder and a coercive force in Example 1 of the invention.

FIG. 3 is a graph showing the relationship between a ratio of oxygen contained in atomized iron powder and iron loss and hysteresis loss coefficient in Example 1 of the invention.

FIG. 4 is a graph showing the relationship between the average particle size of atomized iron powder and coercive force in Example 2 of the invention.

In this regard, in the reference numerals and signs in the figures, 10 is a metal magnetic particle, 20 is an insulating coated film, 30 is a composite magnetic particle, and 40 is an organic substance.

### BEST MODE FOR CARRYING OUT THE INVENTION

Embodiments of the invention will be explained with reference to the figures.

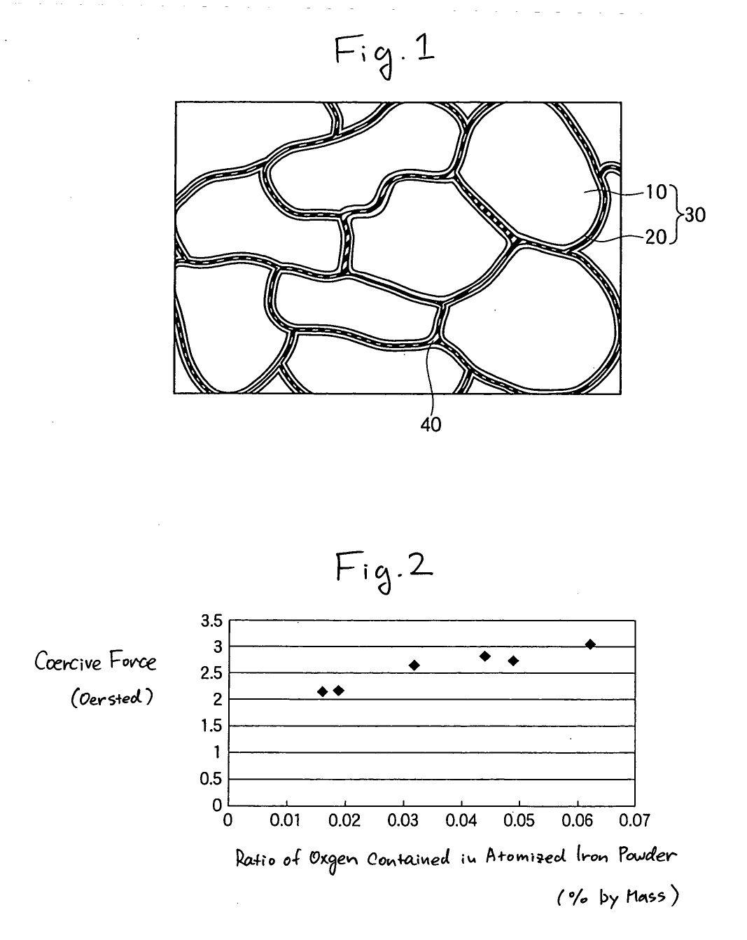

FIG. 1 is a pattern diagram showing a dust core produced using a soft magnetic material in an embodiment of the invention. With reference to FIG. 1, the soft magnetic material comprises a plurality of composite magnetic particles 30 comprising metal magnetic particles 10 and insulating coated films 20 surrounding the surface of the metal magnetic particles 10. Organic substance 40 is present between a plurality of the composite magnetic particles 30. Each of a plurality of the composite magnetic particles 30 is joined by an organic substance 40 or is joined by meshing of unevenness possessed by the composite magnetic particles 30.

The metal magnetic particles 10 contains iron (Fe) and is formed out of iron (Fe), iron (Fe)-silicon (Si)-based alloy, iron (Fe)-nitrogen (N)-based alloy, iron (Fe)-nickel (Ni)-based alloy, iron (Fe)-carbon (C)-based alloy, iron (Fe)-boron (B)-based alloy, iron (Fe)-cobalt (Co)-based alloy, iron (Fe)-phosphorus (P)-based alloy, iron (Fe)-nickel (Ni)-cobalt (Co)-based alloy, iron (Fe)-aluminum (Al)-silicon (Si)-based alloy, or the like. The metal magnetic particles 10 may be composed of elemental iron or an iron-based alloy.

The metal magnetic particles 10 further contain oxygen (O). Oxygen unavoidably contaminates into the metal magnetic particles 10 in the production process of the metal magnetic particles 10. The ratio of oxygen contained in the whole metal magnetic particles 10 is more than 0 and less than 0.05% by mass. More preferably, the ratio of oxygen contained in the whole metal magnetic particles 10 is more than 0 and less than 0.02% by mass. The metal magnetic particles 10 in which the ratio of oxygen is suppressed low as above can be easily obtained by carrying out reductive annealing of the metal magnetic particles 10.

In the case that the ratio of oxygen contained in the metal magnetic particles is measured, there is first prepared only 5 g to 10 g of the soft magnetic powder, which is an assembly of a plurality of the metal magnetic particles 10. Then, compositional analysis by an inductively coupled plasma-mass spectrometry (ICP-MS) is carried out on the soft magnetic powder to measure the ratio of oxygen. The ratio of oxygen thus measured is regarded as the ratio of oxygen contained in the metal magnetic particles 10.

The coercive force of the metal magnetic particles 10 is preferably 2.4×10² A/m (=3.0 oersted) or less. In the case of measuring the coercive force of the metal magnetic particles 10, there is first prepared only several grams of the soft magnetic powder, which is an assembly of a plurality of the metal magnetic particles 10, and then the soft magnetic powder is caked into a pellet using a resin binder to prepare a solid piece composed of the metal magnetic particles 10. To the solid piece, magnetic fields of 1 (T: tesla) →−1 T→−1 T→−1 T are applied in this order and also the shape of an M (magnetization)-H (magnetic field) loop is specified at that time using a sample-vibration type magnetometer (VSM). Then, the coercive force of the solid piece is calculated based on the shape of the MH loop. The thus determined coercive force is regarded as the coercive force of the metal magnetic particles 10.

The average particle size of the metal magnetic particles 10 is preferably from 100 μm and to 300 μm. By controlling the average particle size of the metal magnetic particles 10 to 100 μm or more, the ratio of stress-strain induced by surface energy of the metal magnetic particles 10 relative to the whole metal magnetic particles 10 can be lowered. The stress-strain induced by the surface energy of the metal magnetic particles 10 means stress-strain generated as a result of strains and defects present on the surface of the metal magnetic particles 10. The presence of strain and defects causes inhibition of transfer of the magnetic domain wall. Therefore, by lowering the ratio of stress-strain induced by surface energy relative to the whole metal magnetic particles, the hysteresis loss of the soft magnetic material can be reduced.

On the other hand, in the case that a high frequency wave is applied to the metal magnetic particles 10, a magnetic field is formed only on the surface of the particle owing to a skin effect, and a domain where no magnetic field is formed is generated inside the particle. The domain where no magnetic field is formed generated inside the particle increases the iron loss of the metal magnetic particles 10. Thus, by controlling the average particle size of the metal magnetic particles to 300 μm or less, the generation of the domain where no magnetic field is formed inside the particle is suppressed, whereby the iron loss can be reduced.

In this regard, the average particle size herein is a particle size of the particles, at which the sum of masses of the particles starting from the smallest diameter side reaches 50% of the total mass of the particles in histogram of the particle size measured by a laser scattering diffractometry, i.e., 50% particle size D.

The particle size of the metal magnetic particles 10 is preferably distributed substantially only in the range of more than 38 μm. That is, it is preferable to use the metal magnetic particles 10 wherein particles having a particle size of 38 μm or less are excluded completely. Moreover, the particle size of the metal magnetic particles 10 are more preferaby distributed substantially only in the range of more than 75 μm. In this case, even when the strains and defects present on the surface of the metal magnetic particles 10 are not completely eliminated by the reductive annealing carried out on the metal magnetic particles 10, the above hysteresis loss generated by surface energy of the metal magnetic particles 10 can be sufficiently reduced.

The insulating coated film 20 is formed by subjecting the metal magnetic particles 10 to treatment with phosphoric acid. More preferably, the insulating coated film 20 contains an oxide. As the insulating coated film 20 containing an oxide, oxide insulators such as manganese phosphate, zinc phosphate, calcium phosphate, aluminum phosphate, silicon dioxide, titanium dioxide, aluminum oxide, or zirconium oxide may be used in addition to iron phosphate containing phosphorus and iron.

The insulating coated film 20 functions as an insulating layer among the metal magnetic particles 10. By covering the metal magnetic particles 10 with the insulating coated film 20, the electric resistivity ρ of the dust core can be increased. Thereby, it is possible to suppress the flow of eddy current among the metal magnetic particles 10 to reduce the iron loss caused by the eddy current.

The thickness of the insulating coated film 20 is preferably from 0.005 μm to 20 μm. By controlling the thickness of the insulating coated film 20 to 0.005 μm or more, the energy loss due to the eddy current among the particles can be effectively suppressed. Moreover, by controlling the thickness of the insulating coated film 20 to 20 μm or less, it is possible to prevent the ratio of the insulating coated film 20 relative to the whole from becoming too large. Thereby, a significant decrease of the magnetic flux density of the dust core can be prevented.

As the organic substance 40, thermoplastic resins such as thermoplastic polyimide, thermoplastic polyamide, thermoplastic polyamideimide, polyphenylene sulfide, polyamideimide, polyether sulfone, polyether imide, and polyether ether ketone, non-thermoplastic resins such as high-molecular-weight polyethylene, completely aromatic polyester, and completely aromatic polyimide, and higher fatty acids such as zinc stearate, lithium stearate, calcium stearate, lithium palmitate, calcium palmitate, lithium oleate, and calciumu oleate may be used. Moreover, a mixture of these compounds may be used.

The organic substance 40 functions as a cushioning material among the composite magnetic particles 30 at the time when the pressure-molding step is carried out using the soft magnetic material in the embodiment of the invention. Thereby, the destruction of the insulating coated film 20 by the contact of the composite magnetic particles 30 one another is inhibited.

The ratio of the organic substance 40 relative to the whole of the dust core is preferably more than 0 to 1.0% by mass or less. By controlling the ratio of the organic substance 40 to 1.0% by mass or less, it is possible to secure the ratio of the metal magnetic particles 10 at a certain value or more. Thereby, a dust core having a higher magnetic flux density can be obtained.

The soft magnetic material in the embodiment of the invention provides the metal magnetic particles 10 containing iron and oxygen. The ratio of oxygen contained in the metal magnetic particles 10 is more than 0 and less than 0.05% by mass. The dust core produced using such a soft magnetic material has a coercive force of 2.0×10² A/m (=2.5 oersted) or less.

According to the coercive force of the thus constituted soft magnetic material, since the ratio of oxygen contained in the metal magnetic particles 10 is less than 0.05% by mass or less, the amount of the iron oxides such as FeO and Fe₂O₃ can be suppressed to a low value. Thereby, it is possible to increase the saturated magnetic flux density of the soft magnetic material and decrease the coercive force thereof. Furthermore, by producing a dust core from the soft magnetic material having such magnetic characteristics, the iron loss of the dust core can be reduced mainly through the reduction of the hysteresis loss. Thereby, even in the use of a low-frequency region of, for example, 10 kHz or less, a dust core showing practical and excellent magnetic characteristics can be provided.

In this regard, the soft magnetic material in the present embodiment can be used in electronic parts such as choke coils, switching power-source elements, magnetic heads, various motor components, automobile solenoids, various magnetic sensors, various electromagnetic valves, and the like.

### EXAMPLES

The following will describe specific Examples of the invention in detail.

### Example 1

First, an atomized iron powder to be metal magnetic particles 10 in FIG. 1 was prepared. When the particle size distribution of the atomized powder was measured using a laser scattering diffractometry, the average particle size of the atomized iron powder was found to be 200 μm. Then, the atomized iron powder was placed in an atmosphere of a mixed gas composed of hydrogen and argon and reductive annealing was carried out under conditions of a temperature of 800° C. and 3 hours. On this occasion, the partial pressure of hydrogen relative to the total pressure of the mixed gas 1.01×10⁵ Pa (=1.0 atm) was changed within the range of from 1.01×10⁴ Pa (=0.1 atm) to 1.01×10⁵ Pa. Thereby, in the atomized iron powders of Samples 1 to 6, the ratio of oxygen contained was adjusted.

Using an inductively coupled plasma-mass spectrometry, compositional analysis of the atomized iron powders of Samples 1 to 6 was carried out with respect to O, C, P, and S. Furthermore, a pellet (diameter: 20 mm, thickness: 5 mm) was produced by mixing each of these atomized iron powders and a resin binder, and the coercive force of the pellet was determined using a sample-vibration type magnetometer. Table 1 shows the composition and coercive force of the atomized iron powders of Samples 1 to 6. In combination, the coercive force of an insulation-coated iron powder manufactured by Hoganas (trade name “Somaloy 500”) is shown in Table 1.

TABLE 1

| Atomized | | | | | Coercive |
|---|---|---|---|---|---|
| iron | O (% by | C (% by | P (% by | S (% by | force |
| powder | mass) | mass) | mass) | mass) | (oersted) |
| Sample 1 | 0.016 | 0.001 | 0.0031 | 0.003 | 2.13 |
| Sample 2 | 0.019 | 0.001 | 0.0031 | 0.002 | 2.16 |
| Sample 3 | 0.032 | 0.001 | 0.0030 | 0.002 | 2.61 |
| Sample 4 | 0.044 | 0.001 | 0.0030 | 0.002 | 2.80 |
| Sample 5 | 0.049 | 0.001 | 0.0032 | 0.002 | 2.73 |
| Sample 6 | 0.062 | 0.001 | 0.0030 | 0.003 | 3.04 |
| “Somaloy | — | — | — | — | 3.60 |
| 500” mfd. | | | | | |
| by Hoganas | | | | | |

FIG. 2 is a graph showing relationship between the ratio of oxygen contained in the atomized iron powder and the coercive force in Example 1 of the invention. With reference to Table 1 and FIG. 2, by increasing the hydrogen partial pressure of the mixed gas used at reductive annealing, the ratio of oxygen contained in the atomized iron powder could be decreased. Moreover, in the atomized iron powders of Samples 1 to 5 wherein the ratio of oxygen was less than 0.05% by mass, a relatively low coercive force having 3.0 oersted or less could be obtained.

Next, only 100 cm³ of an aqueous phosphoric acid solution having a concentration of 0.1×10⁻³ mol/cm³ was prepared and 50 g of the atomized iron powder was immersed in the aqueous phosphoric acid solution. The aqueous phosphoric acid solution was stirred under conditions at a rotational speed of 300 rpm for 10 minutes. The acid was completely removed from the atomized iron powder by washing with water and, after further washing with acetone, drying treatment was carried out under conditions of a temperature of 60° C. and 1 hour. By these steps, an atomized iron powder on which a phosphoric acid-coated film was formed as an insulating coated film 20 in FIG. 1.

Then, the atomized iron powder was press-molded at a surface pressure of 5 ton/cm² to 12 ton/cm² to form a ring-shape (outer diameter: 34 mm, inner diameter: 20 mm, thickness: 5 mm) molding. The density of the molding was controlled at a constant value of 7.5 g/cm³. By carrying out a thermal treatment on the molding under conditions of a temperature of 300° C. and 1 hour in a nitrogen atmosphere, a dust core formed out of each of the atomized iron powders of Samples 1 to 6 in Table 1 was finally produced.

In addition, trade name “Somaloy 500” having an average particle size of 90 μm and manufactured by Hoganas was press-molded at a surface pressure of 5 ton/cm² to 12 ton/cm² to form a ring-shape (outer diameter: 34 mm, inner diameter: 20 mm, thickness: 5 mm) molding. The density of the molding was controlled at a constant value of 7.5 g/cm³. By carrying out a thermal treatment on the molding under conditions of a temperature of 300° C. and 1 hour in a nitrogen atmosphere, a dust core for comparison was finally produced.

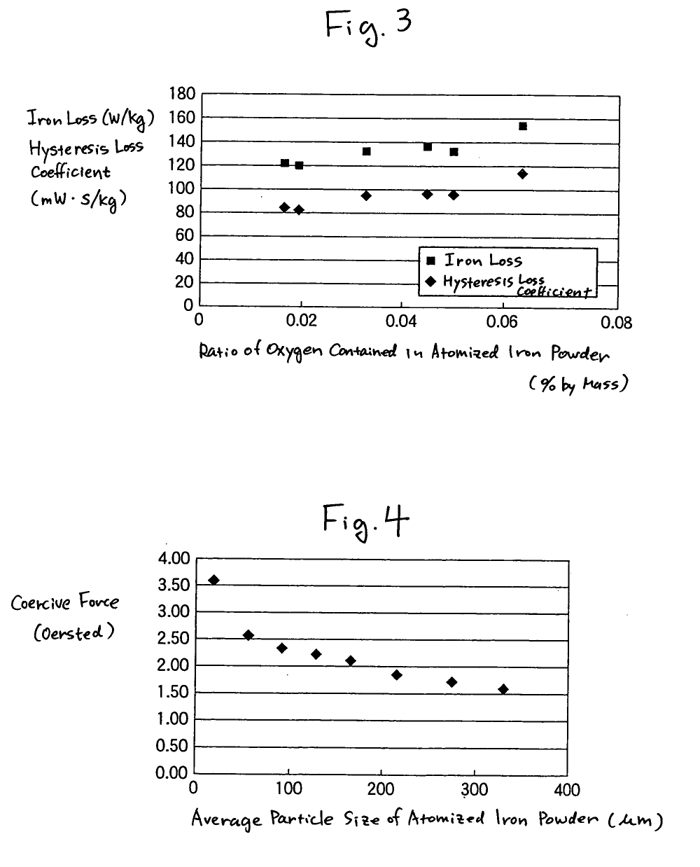

Next, evaluation of magnetic characteristics of the produced dust core was carried out by providing the dust core with a coil (primary number of winding: 300 times, secondary number of winding: 20 times) and applying a magnetic field. On this occasion, with regard to the iron loss of the dust core, a magnetic field having a frequency of 1 kHz was applied with changing within the range of 1.0 T to −1.0 T and the iron loss was determined based on the shape of a BH loop obtained from a BH curve tracer operated at that time. Table 2 shows the iron loss, hysteresis loss coefficient, and eddy current loss coefficient of the dust core obtained from the evaluation, for every atomized iron powder used. FIG. 3 is a graph showing the relationship between the ratio of oxygen contained in the atomized iron powder and the iron loss and hysteresis loss coefficient in Example 1 of the invention.

TABLE 2

| | Atomized iron powder | | | | | | |
|---|---|---|---|---|---|---|---|
| | | | | | | | “Somaloy |
| | | | | | | | 500” |
| | | | | | | | mfd. by |
| | Sample 1 | Sample 2 | Sample 3 | Sample 4 | Sample 5 | Sample 6 | Hoganas |
| Iron loss | 120.5 | 117.6 | 129.4 | 134.2 | 130.5 | 150.3 | 170.3 |
| (W/kg) | | | | | | | |
| Hysteresis | 82.5 | 81.6 | 92.4 | 94.2 | 93.5 | 112.3 | 116.7 |
| loss | | | | | | | |
| coefficient | | | | | | | |
| (mW · s/kg) | | | | | | | |
| Eddy | 0.038 | 0.036 | 0.037 | 0.040 | 0.037 | 0.038 | 0.054 |
| current | | | | | | | |
| loss | | | | | | | |
| coefficient | | | | | | | |
| (mW · s²/kg) | | | | | | | |

As understood with reference to Table 2, in the dust core for comparison using the iron powder “Somaloy 500” manufactured by Hoganas, all of the iron loss, hysteresis loss coefficient, and eddy current loss coefficient were found to be larger values as compared with those of the other results. With reference to FIG. 3, it could be confirmed that both of the iron loss and hysteresis loss coefficient were found to be lower values in the case of using the atomized iron powders of Samples 1 to 5 wherein the ratio of oxygen was less than 0.05% by mass as compared with the case of using the atomized iron powder of Sample 6 wherein the ratio of oxygen was 0.062% by mass. Among them, it could be confirmed that the iron loss and hysteresis loss coefficient were found to become remarkably small particularly in the case of using the atomized iron powders of Samples 1 and 2 wherein the ratio of oxygen was 0.02% by mass or less.

### Example 2

Subsequently, atomized iron powders having different average particle sizes (the composition was the same as in the atomized iron powder of Sample 1 in Example 1) were prepared and the coercive force of each of the atmized iron powders was measured using the same method as in Example 1. Also, for comparison, the coercive force of the atomized iron powder “Somaloy 500” having an average particle size of 90 μm and manufactured by Hoganas was measured. Table 3 shows the values of the coercive force obtained by the measurement, on every average particle size of the atomized iron powders. FIG. 4 is a graph showing the relationship between the average particle size and coercive force of the atomized iron powders in Example 2 of the invention.

TABLE 3

| | Average particle size of atomized iron powder (μm) | | | | | | | | |
|---|---|---|---|---|---|---|---|---|---|
| | | | | | | | | | 90 (“Somaloy |
| | | | | | | | | | 500” mfd. by |
| | 17.5 | 55 | 90.5 | 128 | 165 | 215 | 275 | 327.5 | Hoganas) |
| Coercive | 3.60 | 2.62 | 2.38 | 2.26 | 2.13 | 1.87 | 1.75 | 1.61 | 3.60 |
| force | | | | | | | | | |
| (oersted) | | | | | | | | | |

As understood with reference to Table 3, as compared with the other atomized iron powders, the iron powder “Somaloy 500” manufactured by Hoganas had a large value of coercive force. With reference to FIG. 4 in combination, it could be confirmed that a relatively low coercive force was obtained by controlling the average particle size of the atomized iron powder to 100 μm or more. Moreover, it could be confirmed that the coercive force decreased as the average particle size of the atomized iron powder increased.

Next, the atomized iron powder of Sample 1 in Table 1 having an average particle size of 200 μm was classified using a sieve to prepare an atomized iron powder wherein a powder having a particle size of 38 μm or less was excluded completely and an atomized iron powder having a particle size of 75 μm or less was excluded completely. Using the same method as in Example 1, the coercive force of these classified atomized iron powders and the unclassified atomized iron powder was measured. Table 4 shows the coercive force measured together with the coercive force of the iron powder “Somaloy 500” manufactured by Hoganas.

TABLE 4

| Sieve width | Coercive force (oersted) |
|---|---|
| Unclassified atomized iron powder | 2.08 |
| Atomized iron powder from which | 1.94 |
| 38 μm or less is excluded | |
| Atomized iron powder from which | 1.83 |
| 75 μm or less is excluded | |
| “Somaloy 500” mfd. by Hoganas | 3.60 |

With reference to Table 4, it could be confirmed that the coercive force of the iron powder could be reduced by excluding a powder having a particle size of 38 μm or less. Moreover, it could be confirmed that the coercive force of the iron powder could be further reduced by excluding a powder having a particle size of 75 μm or less.

Embodiments and Examples disclosed herein should be construed as being illustrative but not restrictive in all aspects. The scope of the invention is shown not by the above description but by Claims and it is intended to include all changes which fall within meanings and scopes equivalent to Claims.

While the invention has been described in detail and with reference to specific examples thereof, it will be apparent to one skilled in the art that various changes and modifications can be made therein without departing from the spirit and scope thereof.

The present application is based on Japanese Patent Application No. 2004-024257 filed on Jan. 30, 2004, and the contents are incorporated herein by reference.

### INDUSTRIAL APPLICABILITY

As described in the above, according to the invention, regardless of the frequency to be applied, a soft magnetic material exhibiting excellent magnetic characteristics and a dust core produced from the soft magnetic material can be provided.

1. A soft magnetic material comprising metal magnetic particles containing iron and oxygen, wherein the ratio of the above oxygen contained in the metal magnetic particles is more than 0 and is less than 0.05% by mass.

2. The soft magnetic material according to claim 1, wherein the coercive force of the above metal magnetic particles is 2.4×10² A/m or less.

3. The soft magnetic material according to claim 1 or 2, wherein the average particle size of the above metal magnetic particles is from 100 μm and to 300 μm.

4. The soft magnetic material according to claim 1 or 2, wherein the particle size distribution of the above metal magnetic particles is substantially present only in the range of more than 38 μm.

5. The soft magnetic material according to claim or 2, which comprises a plurality of composite magnetic particles comprising the above metal magnetic particles and insulating coated films surrounding the surface of the above metal magnetic particles.

6. A dust core produced using the soft magnetic material according to claim 1 or 2.

7. The dust core according to claim 6, wherein coercive force is 2.0×10² A/m or less.
